(19) United States
(12) Patent Application Publication
(10) Pub. No.: US 2009/0051932 A1
(43) Pub. Date: Feb. 26, 2009

(54) METHOD FOR DETERMINING THE POSITION OF A MEASUREMENT OBJECTIVE IN THE Z-COORDINATE DIRECTION OF AN OPTICAL MEASURING MACHINE HAVING MAXIMUM REPRODUCIBILITY OF MEASURED STRUCTURE WIDTHS

(75) Inventors: Michael Heiden, Wolfersheim (DE); Klaus Rinn, Heuchelheim (DE)

Correspondence Address: HOUSTON ELISEEVA, 4 MILITIA DRIVE, SUITE 4, LEXINGTON, MA, 02421, US

(73) Assignee: VISTEC SEMICONDUCTOR SYSTEMS GMBH, Weilburg (DE)

(21) Appl. No.: 12/193,095

(22) Filed: Aug. 18, 2008

(30) Foreign Application Priority Data
Aug. 23, 2007 (DE) 10 2007 039 981.4

(51) Int. Cl. G01B 11/14

(52) U.S. Cl. 356/614

(57) ABSTRACT

A method for determining the ideal focus position on different substrates is disclosed. A focus criterion is determined with which the best reproducibility may be achieved. An offset permits the user to set the optimal operating point of the coordinate measuring machine for a reproducible measurement of dimensions of structures on a substrate.

### RELATED APPLICATIONS

This application claims priority to German Patent Application No. 10 2007 039 981.4, filed on Aug. 23, 2007, which is incorporated herein by reference in its entirety.

### FIELD OF THE INVENTION

The invention relates to a method for determining the position of a measurement objective in the Z-coordinate direction of an optical measuring machine where maximum reproducibility of measured structure widths may be achieved on different substrates. The inventive method is essentially used for optical measuring devices for measuring structures and/or structure widths on a substrate.

### BACKGROUND OF THE INVENTION

There are measuring devices measuring the position of structures on a substrate. Such measuring devices are referred to as coordinate measuring machines. Other measuring devices are used for measuring the width of structures (CD=critical dimension). The term measuring machine used in the following will be used both for the coordinate measuring machine and the measuring device for determining the structure widths.

An optical measuring device (coordinate measuring machine) for determining the position of structures on a transparent substrate is disclosed in the German patent application DE-A-198 19 492.7-52. The position of a structure on the substrate is defined by the distance between an edge of the structure and a reference point. The measuring device consists of an incident light illumination means, an imaging means and a detector means for the imaged structures, and a measurement table displaceable interferometrically perpendicularly to the optical axis. The measurement table is designed as an open frame for receiving the substrate. An illumination means is provided beneath the measurement table, whose optical axis is aligned with the optical axis of the incident light illumination means. The measuring machine shown therein also allows measuring the dimensions of the structures on the mask.

An optical measuring system for determining the width of structures on a substrate is known from the not yet published patent application DE 10 2007 032 626.

U.S. Pat. No. 5,789,118 discloses a method for accurately determining the phase-shifting properties of a PSM mask. For this purpose, the dimensions of two structures on the mask are measured. One structure has phase-shifting properties, and the other structure is a so-called binary structure. A comparison of the dimension of the phase-shifting structure and the binary structure yields the shift of the focal position. The method suggested therein can only be used for PSM masks.

The German published application DE 101 08 827 A1 discloses a measuring method for determining the width of a structure on a mask. The width of a structure and its edge inclination angle or its structure contrast are determined by a scanning electron microscope during a focus run. The above features cannot be determined by the optical measuring means in the present invention.

U.S. patent application no. 2003/0158710 discloses a method that allows determining the dimensions of a structure resulting from a photolithographic process. This is accomplished by finding a function establishing a relationship between the measured structural properties and the focus setting of the stepper. The function is used to determine a focus profile suitable for correcting the focus errors of the stepper.

The article “Critical dimension measurements on phase-shift masks using an optical pattern placement metrology tool” by H. Bittner et al. discusses the problem of repeatability of CD measurements on PSM masks, in: Metrology, Inspection, and Process Control for Microlithography XXI, Proc. of SPIE Vol. 6518, 65183H, 10 pages, April 2007.

The article “Actual Performance Data Obtained on New Transmitted Light Metrology System” by K. Roeth, G. Schlueter discusses the construction of a coordinate measuring machine and identifies the limits of resolution, in: 18th European Conference on Mask Technology for Integrated Circuits and Microcomponents, Proc. of SPIE Vol. 4764, pp. 161-167, 2002.

For measuring the dimensions of the structures and also for determining the position of structures on a substrate, it is necessary to first determine the focal position. Depending on the position of the focus, different measurement values are obtained for the dimensions of the structures on the surface of a substrate or for the determination of the position of the structure. Thus it is necessary to determine the ideal focal position for each type of substrate. Determining the position of at least one structure on a substrate or determining the width of a structure first requires acquiring an image stack. For this purpose, the objective is moved in the Z-coordinate direction (perpendicularly to the substrate).

Then the sharpest image in this stack is identified. The sharpest image is defined by the current measuring task and the sharpness algorithm (focus criterion) used for this task. The sharpness algorithm is the method used for determining the focus criterion. Generally, an interpolation is performed between the images. Based on an image stack acquired in the Z-coordinate direction, the focus criterion is determined, wherein a focus value is assigned to each image of the image stack. The image with the extremal focus value is identified from the image stack. An area within which the focus values are fitted with a function is determined around this image by the user.

The focus criterion, i.e. the mathematical function determining the sharpest image in the image stack, is very sensitive with respect to substrate properties. Therefore, a focus criterion yielding excellent results for the CD determination (determination of the width of structures) on CoG masks is generally not suitable for performing the same task on PSM masks. Due to the large variety of PSM mask types, it is not possible to develop a perfect algorithm for this type of masks. A new type of mask will immediately require the costly development and testing of a corresponding new focus criterion.

The present invention allows adapting an existing algorithm to a new type of mask in an easy way. The adaptation may be performed by the customers themselves and does not require any adaptation of the software.

### SUMMARY OF THE INVENTION

It is the object of the invention to provide a method for determining the ideal position of a measurement objective in the Z-coordinate direction that, on different substrates (mask types), reliably yields reproducible measurement results of the dimensions of the structures on the substrate, irrespective of the type of substrate.

This object is achieved by a method for determining the position of a measurement objective in a Z-coordinate direction of an optical measuring machine where there is the best reproducibility of measured structure widths depending on variations of the focus position of the measurement objective in the Z-coordinate direction to set an optimal operating point of an optical measuring machine, comprising the steps of:

imaging at least one structure to be measured onto a detector of a camera, wherein the measurement objective is moved in the Z-coordinate direction to obtain an image stack of the structure to be measured with different focus positions of the measurement objective;

assigning a focus value to each image of the image stack;

identifying the image with the extremal focus value from the image stack, wherein the user determines an area around this image within which the focus values are fitted with a function;

calculating a structure width for each image in the area around the focal point determined by the user; and

determining an offset with respect to a determined extremal focus value of the focus position which yields an optimal position of the measurement objective in the Z-coordinate direction, so that measurements of dimensions of structures on a substrate are essentially constant with respect to variations of the position of the measurement objective in the Z-coordinate direction.

The inventive method for determining an ideal focus position for at least one substrate has the advantage that it sets an optimum operating point of an optical measuring machine. First, a structure to be measured is imaged onto a detector of a camera. Among at least one focus criterion, the one achieving the best reproducibility is determined. Finally, an offset with respect to a determined extreme of the focus position is determined. The offset allows setting the optimum operating point of the optical measuring machine for a reproducible measurement of dimensions of structures on a substrate.

The focus criterion is determined based on an image stack acquired in the Z-coordinate direction, wherein a focus value is assigned to each image of the image stack. The image having the extremal focus value is identified from the image stack, wherein an area within which the focus values are fitted with a suitable function is determined around this image by the user.

A suitable function may be a parabola. The extreme of this function is determined. Higher degree polynomials may also be used as suitable functions.

In the area determined by the user, the dimension of the structure or structures is calculated around the focal point for each image. A suitable function is fitted for the dimension of the structure within the area determined by the user, wherein this function is evaluated at the location of the position of the extreme of the focus criterion, and wherein the value calculated therefrom is output to the user as measured dimension of the structure.

Based on the function, an extreme of the measured dimension of the structure is determined. The offset is determined from the difference of the position of the extreme of the function for the focus value and the position of the extreme of the function for the dimension of the structure, wherein graphs regarding the position of the extreme of the function for the focus criterion and the position of the extreme of the function for the dimension of the structure are shown on a display of the measuring machine, and wherein the offset is read from the graphs provided by the measuring machine and input into the optical measuring machine by the user for a later measurement.

The optical measuring machine automatically determines the position of the extreme of the function for the dimension of the structure from a measurement and outputs the offset with respect to the focus criterion on the display. The determination of the offset is performed automatically, wherein an optimization run for determining the optimal offset is performed by the optical measuring machine prior to the actual measurement.

The optical measuring machine performs N measurements, wherein the reproducibility of the measurement is determined from these N measurements. The offset is varied and the reproducibility is again determined, wherein the offset is varied until a minimum is reached in the reproducibility of the measurement of the dimension of the structure.

After the determination of the offset, the actual measurement of the dimension of several structures on a substrate is performed, wherein the measurement of dimensions of structures on a substrate is the measurement of line widths of structures on masks of the semiconductor production. Recipes for measuring tasks may be automatically generated from the CAD data of the mask. Several offset values for various line widths may be necessary, so that they are determined once for one mask type and stored in a table. The tables may be used for the automatic generation of the recipes.

The offset may be determined for various structure widths, wherein the respective values are stored in a database.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 shows an optical measuring machine implemented as a coordinate measuring machine in the embodiment shown, wherein the substrate is illuminated in transmitted light and/or incident light, and wherein the measurement of the dimension of structures and the position of structures on a substrate is performed;

FIG. 2 shows a schematic representation of a substrate on whose surface there are shown several structures to be measured by the coordinate measuring machine;

FIG. 3a shows the focus criterion for each image from an image stack, wherein a suitable function with which the maximum of the focus criterion may be interpolated was fitted around the maximum;

FIG. 3b shows the calculated CD (critical dimension) in each image of the image stack, wherein the minimum of the CD does not coincide with the maximum in the focus criterion;

FIG. 4a shows a representation corresponding to FIG. 3a, wherein a value offset by a fixed amount with respect to the extreme is used for further evaluation instead of the extreme of the focus criterion; and

FIG. 4b shows the use of the measurement (CD measurement) in the offset focus position.

### DETAILED DESCRIPTION OF THE PREFERRED EMBODIMENTS

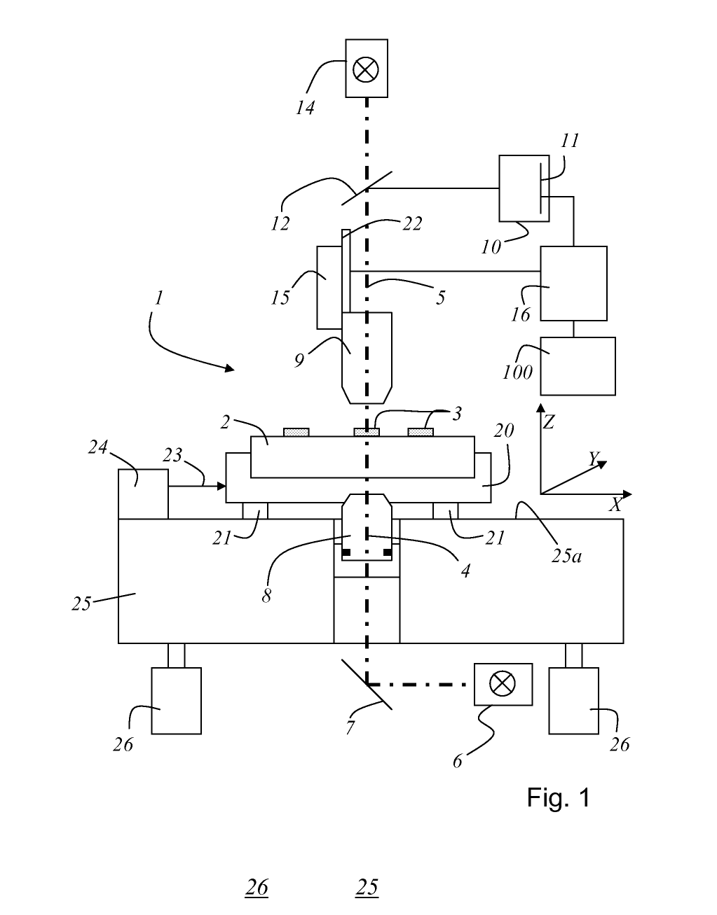

A coordinate measuring device is exemplarily shown as optical measuring machine. It is obvious for someone skilled in the art that the inventive method may also be used in other optical measuring machines. These are, for example, optical measuring machines used for determining the width (CD critical dimension) of a structure on a substrate. Several coordinate measuring devices 1 of the type shown in FIG. 1 are already known from prior art. For the sake of completeness, however, the operation and arrangement of each element of the coordinate measuring device 1 will be described. The coordinate measuring device 1 includes a measurement table 20 arranged on air bearings 21 to be movable in a plane 25a in the X-coordinate direction and in the Y-coordinate direction. Other bearings than the air bearings may also be used for bearing the measurement table 20. The plane 25a is formed of an element 25. In a preferred embodiment, the element 25 is granite. However, it is clear to someone skilled in the art that the element 25 may also be formed of any other material guaranteeing an exact plane 25a for the translation of the measurement table 20. The position of the measurement table 20 is measured by means of at least one laser interferometer 24 emitting a light beam 23 for the measurement. The element itself is positioned on vibration dampers 26 to thus keep building vibrations away from the measuring device.

A substrate 2 carrying the structures 3 to be measured is deposited on the measurement table 20. The substrate 2 may be illuminated by a transmitted light illumination means 6 and/or an incident light illumination means 14. The light of the transmitted light illumination means 6 reaches the substrate 2 via a deflecting mirror 7 and a condenser 8. Likewise, the light of the incident light illumination means 14 reaches the substrate 2 via a measurement objective 9. The measurement objective 9 is provided with an adjusting means 15 allowing the adjustment of the measurement objective 9 in the Z-coordinate direction. The measurement objective 9 collects the light coming from the substrate 2 and directs it out of the incident light illumination axis 5 by means of a partially transmitting deflecting mirror 12, and directs it to a camera 10 provided with a detector 11. The detector 11 is connected to a computer system 16 generating digital images from the measured values determined by the detector 11.

Furthermore, the adjusting means 15 is connected with a focus position provider 22 providing the focus position of the objective 9 relative to the substrate 2 and monitoring and controlling the focusing of the objective 9 on the substrate surface. The positions of the edges of the individual structures 3 on the surface of a substrate 2 may be detected by the camera 10, which includes an imaging detector 11. The dimension of the structure 2 (structure width) may also be calculated from the position of the edges.

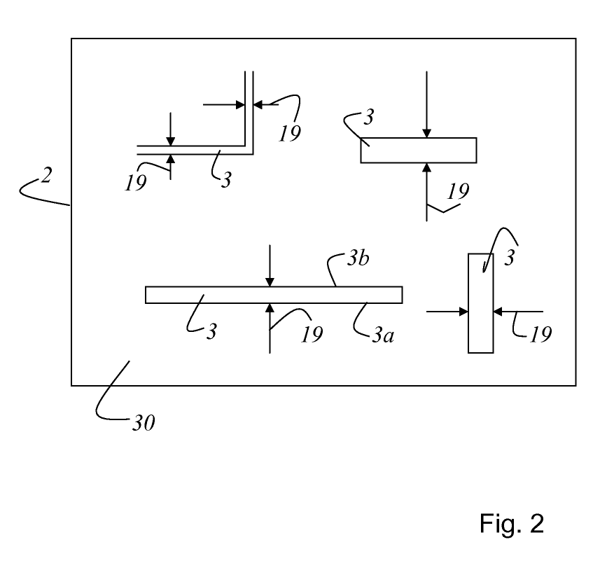

FIG. 2 schematically shows a substrate 2 with several structures 19 located on its surface 30. In the preferred embodiment, the substrate 2 is a mask for the semiconductor production. The mask generally consists of a glass substrate having the structures 3 thereon. Each of the structures 3 has a width, which is indicated by a pair of arrows in FIG. 2. In order to determine this width, a first edge 3a is approached by the measuring means, and its position is determined. Then a second edge 3b is approached, and its position is also determined. The width or dimension of the measured structure is calculated from the two positions. An exact determination of the focal position is required for determining the position of the edges of the structure 19, because the position of the edge may be found at different locations depending on the focal position.

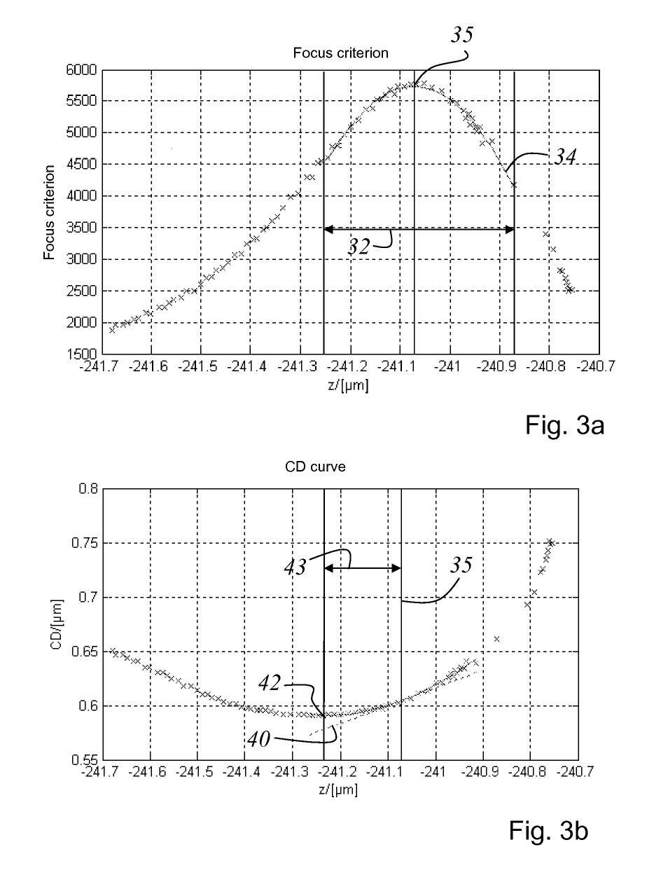

FIG. 3 shows how to determine the optimum focal position of a substrate 2. For this purpose, an image stack is acquired by moving the objective 9 in the direction of the optical axis 5 oriented in the Z-coordinate direction. Then a focus value is assigned to each image. Any method known from literature may be used for this purpose. Then the image having the highest focus value is identified. It is obvious that, with another criterion, there may also be a minimum. An area 32 determined by the user is fitted with a suitable function 34 (continuous line in FIG. 3a) around this image. A suitable function 34 could, for example, be a parabola. The extreme 35 of this function is determined. In the case of a parabola, this is very easy. In the next step, the CD (critical dimension) is calculated for each image in the area 32 around the focal point determined by the user, a suitable function is fitted, and this function is evaluated at the location of the focal point. The function may be a parabola. A polynomial of a degree equal to or larger than 2 could also be used. This is then called the measured dimension (or “critical dimension”) and output to the user (see FIG. 3b). The output for the user is generally performed on a display 100 associated with the measuring device 1.

The disadvantage of the method described in FIG. 3b is that the measurement takes place at locations where the operation is not at the ideal operating point of the measuring machine for the determination of this dimension. The derivative 40 of the CD with respect to the position of the objective (red broken line) is thus not zero at the focus position. Any small variation in the determination of the focus criterion thus immediately results in another CD width. The extreme 35 of the focus criterion and the extreme 42 of the CD are not at the same location, because this depends on the focus criterion chosen and the type of mask used. For CoG masks, the positions still correlate quite well, but in the example of a phase shift mask shown in FIG. 3a they are about 185 nm apart. Due to measurement errors, it is not possible to find exactly the same focal point again and again. Therefore, if several measurements are conducted one after the other, a slightly different focal point will be found each time. Since, at locations other than the extreme, the CD width varies greatly with the focal position, a large spread of the CD values will be obtained.

Therefore, there are typically various focus criteria in the measuring devices from which the most suitable may be selected. However, it is possible that, for new mask types or new processes and applications, no focus criterion is found to be suitable. In this case, a lengthy search for new algorithms is necessary, and these must be implemented and tested. Normally, only a further special case will have been created in this way.

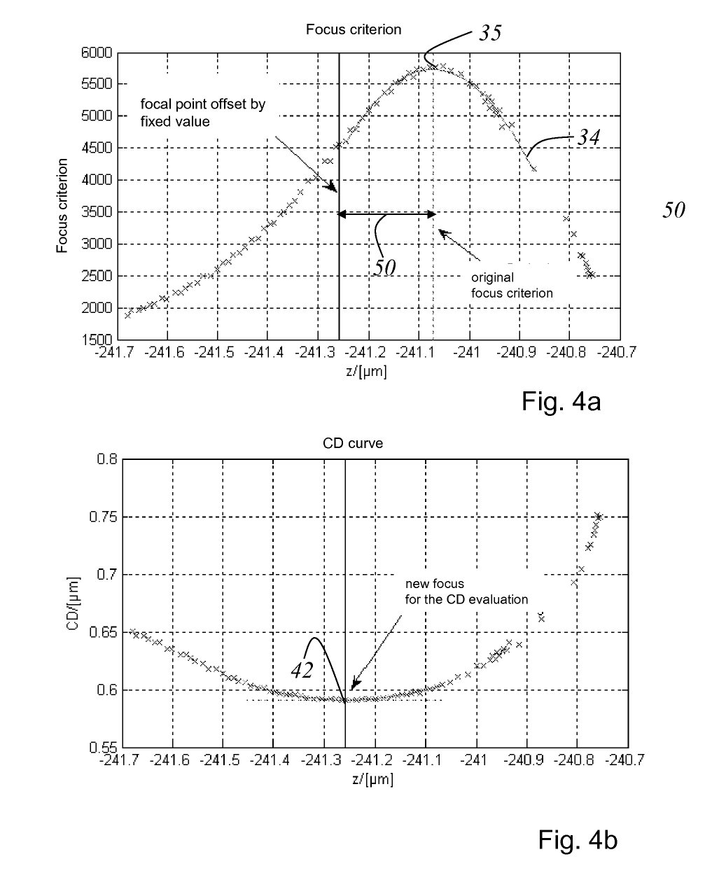

It has been found that, for a certain mask type, the difference between the extreme 35 in the focus criterion and the extreme 42 of the CD always has the same distance 43 or only depends on few easily controllable parameters. Therefore it is possible to allow users to apply a fixed offset value 50 to their chosen focus criterion to measure in the minimum 42 of the CD curve (see also FIGS. 4a and 4b). First the focal point is determined in the conventional way. Then the value given by the user is added (in this case 185 nm), and then the CD is evaluated at this offset point (or minimum 42). It can be seen that small variations in the focus will hardly influence the CD, because the derivative 40 of the CD is zero in the offset focal point. The CD is evaluated at the offset focus position. Although small variations in the original focus position cannot be avoided and, due to the constant offset, are also transferred to the new focus position, this location is insensitive to these variations because the derivative at this location is zero (red broken line). The CD reproducibility becomes higher.

The direct search for the extreme 42 of the CD as focus criterion is not always suitable, because there may be graphs without any extreme. In this case, the user would use a part of the curve characterized by maximum flatness for the CD evaluation. Even if there is an extreme, it is not always the best choice. If the CD curve is very asymmetric with respect to the extreme, it is generally better to go a little to the flatter side for the evaluation.

Therefore, the procedure for a new measurement is as follows:

From the set of available focus criteria, chose the one yielding the best reproducibility.

The offset 50 of the CD with respect to this focus criterion is determined. The offset is most preferably provided automatically by the measuring device 1. However, this is only possible if there is a clearly identifiable extreme that may easily be determined by a computer. Otherwise, the user must input a suitable offset. The offset may be read from graphs displayed on a display 100 of the measuring device 1 (similar to the representations in FIGS. 3a and 3b; as well as 4a and 4b). For this purpose, a measurement is conducted and the corresponding graphs are output on the display 100. The measuring device 1 further has associated therewith a control and monitoring unit 16 (computer) performing the required calculations. The measuring device 1 determines the position of the CD extreme (if any) itself from a measurement and outputs the deviation from the focus criterion on the display 100. The measuring device 1 conducts N measurements and varies the offset until there is a minimum of reproducibility. The offset with respect to the minimum reproducibility is output. This method is also used for highly asymmetric graphs of the CD around the extreme to obtain optimal results.

Particularly the conducting of N measurements and the identification of the optimal offset may be completely automated. In this case, the user would operate the measuring device as previously, but a short optimization run for determining the optimal offset would be performed prior to the actual measurement.

Recipes for measuring tasks are often generated automatically from the CAD data of the mask. When the offsets (several offset values may, for example, be necessary for different line widths) have been determined once for a type of mask, they may be stored in a table (not shown), which may be used for the automatic generation of the recipes. In this case, the values have to be determined only once.

Although the method has been described for the measurement of CD values, it may also be generalized to apply to any other measurands. The measuring device would thus optimize itself automatically for the application and the mask type of the user (if an automated form is used for identifying the suitable offset). Optimization means the best reproducibility.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for determining the position of a measurement objective in a Z-coordinate direction of an optical measuring machine where there is the best reproducibility of measured structure widths depending on variations of the focus position of the measurement objective in the Z-coordinate direction to set an optimal operating point of an optical measuring machine, comprising the steps of:
imaging at least one structure to be measured onto a detector of a camera, wherein the measurement objective is moved in the Z-coordinate direction to obtain an image stack of the structure to be measured with different focus positions of the measurement objective;
assigning a focus value to each image of the image stack;
identifying the image with the extremal focus value from the image stack, wherein the user determines an area around this image within which the focus values are fitted with a function;
calculating a structure width for each image in the area around the focal point determined by the user; and
determining an offset with respect to a determined extremal focus value of the focus position which yields an optimal position of the measurement objective in the Z-coordinate direction, so that measurements of dimensions of structures on a substrate are essentially constant with respect to variations of the position of the measurement objective in the Z-coordinate direction.

2. The method of claim 1, wherein the function is a polynomial of a degree equal to or larger than two.

3. The method of claim 1, wherein a suitable function is fitted for the measured dimension of the structure within the area determined by the user, wherein this function is evaluated at the location of the position of the extremal focus value of the focus position, and wherein the value calculated therefrom is output to the user as the measured dimension of the structure.

4. The method of claim 3, wherein the suitable function is a polynomial of a degree equal to or larger than two.

5. The method of claim 3, wherein an extreme of the measured dimension of the structure is determined from the function.

6. The method of claim 1, wherein the offset is determined from the difference of the position of the extremal focus value of the focus position and the position of the extreme of the function for the dimension of the structure.

7. The method of claim 6, wherein graphs regarding the position of the extremal focus value of the focus position and the position of the extreme of the function for the dimension of the structure are displayed on a display of the measuring machine, wherein the offset is read from the graphs provided by the measuring machine and is input into the optical measuring machine by the user for a later measurement.

8. The method of claim 6, wherein the optical measuring machine automatically determines the position of the extreme of the function for the dimension of the structure from a measurement and outputs the offset with respect to the extremal focus value of the focus position on the display.

9. The method of claim 6, wherein the optical measuring machine conducts N measurements, wherein the reproducibility of the measurement is determined from these N measurements, wherein the offset is varied and the reproducibility is determined again, and wherein the offset is varied until there is a minimum in the reproducibility of the measurement of the dimension of the structure.

10. The method of claim 9, wherein the offset is determined automatically, and wherein an optimization run for determining the optimal offset is performed by the optical measuring machine prior to the actual measurement.

11. The method of claim 1, wherein the offset is determined for various structure widths, and that the respective values are stored in a database.

12. The method of claim 1, wherein the actual measurement of the dimension of several structures on a substrate is performed after the determination of the offset.

13. The method of claim 1 wherein the measurement of dimensions of structures on a substrate is the measurement of line widths of structures on masks of the semiconductor production.

14. The method of claim 13, wherein recipes for measuring tasks are automatically generated from the CAD data of the mask.

15. The method of claim 14, wherein several offset values are necessary for different line widths, wherein these are determined once for a type of mask and stored in a table, and wherein the tables are used for the automatic generation of the recipes.
